(19) United States
(12) Patent Application Publication
(10) Pub. No.: US 2004/0196882 A1
(43) Pub. Date: Oct. 7, 2004

(54) Optical amplifier

(75) Inventors: Haruo Nakaji, Yokohama-shi (JP); Toshikazu Shibata, Yokohama-shi (JP); Yoji Ishizawa, Chigasaki-shi (JP)

Correspondence Address: MCDERMOTT WILL & EMERY LLP, 600 13TH STREET, N.W., WASHINGTON, DC, 20005-3096, US

(73) Assignee: Sumitomo Electric Industries, Ltd.

(21) Appl. No.: 10/814,287

(22) Filed: Apr. 1, 2004

(30) Foreign Application Priority Data
Apr. 1, 2003 (JP) P2003-098558

(51) Int. Cl. H01S 3/091

(52) U.S. Cl. 372/70

(57) ABSTRACT

The present invention relates to an optical amplifier that can operate with low electric power consumption and can sufficiently compensate for the variation of gain spectrum induced by temperature fluctuation. The optical amplifier comprises an amplification optical fiber, a pumping light supplier, and a gain equalizer. The light inputted to the optical amplifier is amplified in the amplification optical fiber, and thereafter the amplified light passes through the gain equalizer. By passing the amplified light through the gain equalizer, the gain spectrum of the amplification optical fiber is equalized and the temperature dependence of the gain spectrum is compensated. At this time, the wavelength of the pumping light supplied from the pumping light supplier to the amplification optical fiber is set such that the gain variation spectrum of the amplification optical fiber depending on temperature becomes smooth. Thus, the amplification optical fiber is supplied with the pumping light whose wavelength is suitable for compensating for the temperature dependence of the gain spectrum.

### BACKGROUND OF THE INVENTION

1. Field of the Invention

The present invention relates to an optical amplifier amplifying signal light of multiplexed plural channels.

2. Related Background Art

In a wavelength division multiplexing (WDM) communication system transmitting signal light of multiplexed plural channels with wavelengths different from each other, it has been required to increase transmission capacity and transmission distance. Therefore, an Erbium-doped fiber amplifier (EDFA), as an optical amplifier used for a WDM communication system, has been needed to widen its amplification band and flatten its gain spectrum. In addition, there has recently been a need for reducing electric power consumption of EDFA in the viewpoint of cost efficiency.

It is known that the gain spectrum of the Erbium-doped fiber amplifier (EDF) varies with temperature fluctuation. Such temperature dependence of the gain spectrum becomes a factor making flattening of the gain spectrum difficult. Accordingly, a conventional EDFA, in order to suppress the temperature dependence of the gain spectrum, is constituted so as to keep the temperature of the EDA at a constant value by temperature control. However, such configuration is problematic in that the temperature control increases the electric power consumption of the entire EDFA, thereby decreasing cost efficiency of the WDM transmission system itself.

Thus, there have been proposed techniques which reduce the gain spectrum variation of EDF due to temperature fluctuation without temperature control in, for example, Document 1: U.S. Pat. No. 6,246,512; Document 2: T. Tsuda et al., OWA4, OAA200; Document 3: Y. Ishii et al., Mo. B. 3.4, ECOC2002; Document 4: Y. Ishii et al., JW3, 0AA2001; and Document 5: K. W. Bennett et al., PD4, OAA′97. These techniques, in order to compensate for the gain spectrum variation of the EDF due to temperature fluctuation, apply a gain equalizer whose loss spectrum varies in accordance with temperature fluctuation in an EDFA.

### SUMMARY OF THE INVENTION

The inventors have studied conventional optical amplifiers in detail, and as a result, have found problems as follows. Namely, in the EDFA, light of 1480 nm-band or 980 nm-band is used as pumping light. As considering that 980 nm-band laser light sources that require no temperature control have been developed, the use of pumping light with 980 nm-band is more advantageous in reducing the electric power consumption of the EDFA. Here, when the pumping light with the 980 nm-band is used, the gain spectrum also varies with variations of the center wavelength of the pumping light, due to pump mediated inhomogeneity (PMI) (see, for example, Document 5). Such variations of the gain spectrum of the EDF due to the variations of the center wavelength of 980 nm-band pumping laser can be suppressed such that the center wavelength is stabilized by using for example, a fiber Bragg grating (FBG).

However, it has not been known that even when the center wavelength of the 980 nm-band pumping laser is stabilized, the temperature dependence of the gain spectrum varies every stabilized center wavelengths. That is, conventionally, gain equalizers that can sufficiently compensate for the temperature dependence of the gain spectrum of the EDF have not been designed.

In order to overcome the above-mentioned problems, it is an object of the present invention to provide an optical amplifier that can operate with low electric power consumption and that can sufficiently compensate for gain spectrum variations due to temperature fluctuation.

By earnestly conducting researches, the present inventors have found that the temperature dependence of the gain spectrum of an optical amplifier varies depending on the center wavelength and that there are some center wavelength values of the pumping light which facilitate compensation for the temperature dependence of the gain spectrum, and therefore have arrived at the present invention. In other words, an optical amplifier according to the present invention, to solve the above-mentioned problems, comprises an amplification medium, a pumping light supplier, and an equalizer. The amplification medium has a light propagation region which is doped with a rare earth element and in which light (signal light) propagating therethrough is amplified by the supply of pumping light with a predetermined wavelength. The pumping light supplier supplies pumping light, whose wavelength is set such that the gain variation spectrum of the amplification medium depending on temperature becomes smooth, to the amplification medium. And, the equalizer equalizes the gain spectrum of the amplification medium and compensates for the temperature dependence of the gain spectrum of the amplification medium.

In this specification, the above-mentioned gain variation spectrum means as a spectrum corresponding to the difference when subtracting the gain spectrum (reference spectrum) the amplification medium at the temperature of 25° C. from the gain spectrum of the amplification medium at a predetermined temperature. Also, the pumping light supplier may be provided at the condition such that the wavelength of the pumping light to be outputted is preliminarily set, or may have a structure that can adjust the wavelength of the pumping light in optical amplification of the optical amplifier.

The light inputted to the optical amplifier is amplified in the amplification medium by the supply of the pumping light form the pumping light supplier. At this time, the wavelength of the pumping light, supplied from the pumping light supplier to the amplification medium, is set such that the above-defined gain variation spectrum of the amplification medium depending on temperature becomes smooth. Thus, an optical amplifier capable of sufficiently compensating for the temperature dependence of the gain spectrum can be realized. Additionally, the optical amplifier does not require temperature control of the amplification medium. Therefore, electric power consumption can be reduced and thereby superior cost effective can be achieved.

In the optical amplifier according to the present invention, the pumping light supplier preferably supplies the pumping light having the wavelength fixed in the wavelength band of 960 nm or more but 990 nm or less. In this case, the temperature dependence of the gain spectrum of the amplification medium varies depending on the pumping light wavelength, and therefore the optical amplifier according to the present invention is particularly useful. Further, the pumping light supplier more preferably supplies the pumping light with the wavelength fixed in the wavelength range of 974 nm or more but 977 nm or less. In this case, it becomes easy to compensate for the temperature dependence of the gain spectrum.

Here, it is preferable that the amplification band of the amplification medium includes wavelengths of 1540 nm or less. In such a wavelength band, the temperature dependence of the gain varies depending on the pumping light wavelength, and therefore the optical amplifier according to the present invention is particularly useful.

The equalizer preferably includes one ore more long-period fiber gratings each having a loss spectrum with a temperature dependence. Here, the long-period fiber grating means as a grating coupling the core mode light with the grating wavelength into the cladding mode light. For example, when the equalizer includes one ling-period fiber grating, the temperature dependence of the gain spectrum can be compensated with a simple configuration. On the other hand, when the equalizer includes a plurality of long-period fiber grating, a complex loss spectrum characteristic can be realized by suitably combining these long-period fiber gratings. That is, the temperature dependence of the gain spectrum can be sufficiently compensated even when the gain spectrum has the complex characteristic.

The long-period fiber grating preferably has a constant period and a constant phase of reflective index variation along its longitudinal direction. In this case, it is possible to realize a long-period fiber grating having a loss spectrum with temperature dependence, since temperature fluctuation causes wavelength shift.

The long-period fiber grating preferably includes an optical fiber that comprises a core extending along a predetermined axis and a cladding provided on an outer periphery of the core, and in which the core only is doped with Ge. In this case, it is possible to easily realize a long-period fiber grating whose wavelength shift due to temperature fluctuation is large. Accordingly, even when the gain spectrum variation due to temperature fluctuation is large, the temperature dependence of the gain spectrum can be easily and sufficiently compensated.

Furthermore, the long-period fiber grating preferably has a loss spectrum whose variation is 40 pm/° C. or more. In this case, even when the gain spectrum due to temperature fluctuation varies by a large amount, the temperature dependence of the gain spectrum can be easily and sufficiently compensated.

The equalizer may include a filter having a constant loss spectrum with no temperature dependence. In this case, the gain spectrum can be equalized with a simple configuration. Also, the filter is preferably a fiber Bragg grating, and therefore it is possible to realize a complex loss spectrum. Accordingly the gain spectrum can be sufficiently equalized even when the gain spectrum has a complex characteristic. Here, the equalizer is not limited to the fiber Bragg grating, and can include other optical elements, for example a dielectric interference filter, such that can sufficiently compensate for the gain spectrum variation due to temperature fluctuation. The Fiber Bragg grating means as a short-period grating reflecting light with a grating wavelength in a direction opposite to the traveling direction of the light.

Furthermore, the pumping light supplier may include a stabilizer for stabilizing the center wavelength of the pumping light. In this case, since the center wavelength of the pumping light to be supplied to the amplification medium is kept at a constant value, the gain spectrum variation due to the center wavelength fluctuation of the pumping light can be effectively suppressed.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view showing a configuration of one embodiment of an optical amplifier according to the present invention;

FIG. 2 is a view showing a configuration of a gain equalizer included in the optical amplifier shown in FIG. 1;

FIG. 3 is a view showing a modification of the pumping light supplier shown in FIG. 1;

FIG. 4 is a view showing a configuration of an experiment system for determining the relationship between the gain spectrum of the amplification optical fiber and the pumping light wavelength;

FIGS. 5A to 5C are graphs showing the temperature dependence of the gain spectra of the amplification optical fiber in the case that the pumping light wavelength is set to 973.3 nm, 975.7 nm, and 980.2 nm, respectively;

FIGS. 6A and 6B are graphs showing the gain variation spectra when the temperature of the amplification optical fiber 13 is changed from 25 to 65° C. and from 25 to 0° C., respectively;

FIG. 7 is a view showing a configuration of an experiment system used for the experiments for actually performing the compensation for the temperature dependence of the gain spectrum of the amplification optical fiber, in the case that the pumping light wavelength is set to 975.7 nm;

FIGS. 8A and 8B are graphs respectively showing the temperature dependence of the gain spectrum and the gain variation spectrum of the amplification optical fiber, in the case that the pumping light wavelength is set to 975.7 nm;

FIGS. 9A and 9B are graphs respectively showing temperature dependence of the loss spectrum and the loss gain spectrum of the gain equalizer actually configured with reference to FIG. 8; and

FIGS. 10A and 10B are graphs respectively showing temperature dependence of the gain spectrum and the gain variation spectrum of the entire amplification optical fiber including the gain equalizer.

### DETAILED DESCRIPTION OF THE PREFERRED EMBODIMENTS

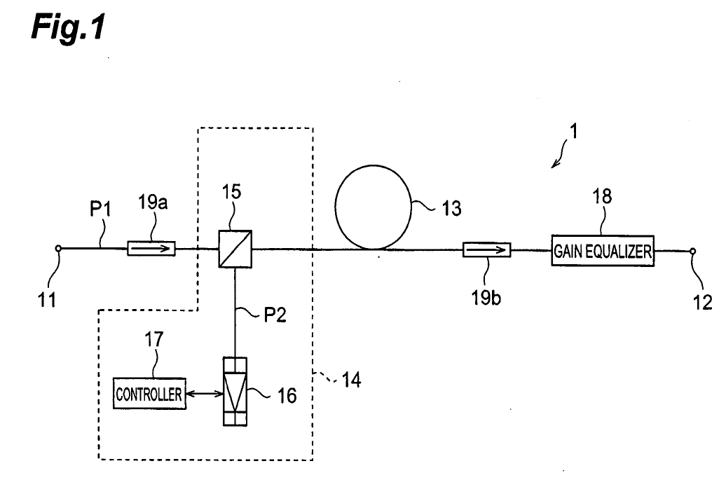

In the following, embodiments of an optical component, an optical device and an optical communications system according to the present invention will be explained in detail with reference to FIGS. 1 to 4, 5A to 6B, 7, and 8A to 10B. In the explanation of the drawings, constituents identical to each other will be referred to with numerals identical to each other without repeating their overlapping descriptions.

FIG. 1 is a view showing a configuration of one embodiment of an optical amplifier according to the present invention. The optical amplifier 1 shown in FIG. 1 is an optical device amplifies light inputted through a light input terminal 11 and outputs the amplified light through a light output terminal 12. The optical amplifier 1 comprises an amplification optical fiber 13 as an amplification medium, a pumping light supplier 14, and a gain equalizer 18 as an equalizer.

The amplification optical fiber 13 is located on the light propagation path P1 extending from the light input terminal 11 to the light output terminal 12, and the amplification optical fiber 13 is an amplification medium including an Erbium-doped optical fiber (EDF). The EDF has a light propagating region through which the light inputted from one end thereof, and the light amplified in the light propagating region is outputted from the other end thereof. The amplification band of the amplification optical fiber 13 includes the C-band (1530 nm to 1565 nm).

The pumping light supplier 14 comprises an optical coupler 15, a pumping light source 16 and a controller 17, and supplies the pumping light with a predetermined wavelength into the amplification optical fiber 13. On the light propagation path P1, the optical coupler 15 is disposed at a position upstream from the amplification optical fiber 13 (or a position closer to the light input terminal 11 than the amplification optical fiber 13). The optical coupler 15 receives light from the light input terminal 11 and outputs the light to the amplification optical fiber 13. Also, the optical coupler 15 is connected to one end of a pumping light propagation path P2 and outputs the pumping light inputted from the path P2 to the amplification optical fiber 13.

The pumping light source 16 is connected to the other end of the pumping light propagation path P2. The pumping light source 16 outputs pumping light to be supplied into the amplification optical fiber 13. For example, the pumping light source 16 may be a semiconductor laser emitting laser light with 980 nm-band.

The controller 17 is connected to the pumping light source 16. The controller 17 properly changes and sets the power and the center wavelength of the pumping light outputted from the pumping light source 16. For example, when the pumping light source 16 is a Fabry-Perot resonator, the controller 17 sets the center wavelength of the pumping light outputted from the pumping light source to a desired value by properly changing or setting the resonator length through temperature control, and the like.

At this time, the center wavelength of the pumping light set by the controller 17 is determined based on the relationship between the temperature dependence of the gain spectrum of the amplification optical fiber 13 and the center wavelength of the pumping light supplied to the amplification optical fiber 13. In other words, the wavelength of the pumping light is set such that the gain variation spectrum of the amplification optical fiber 13 depending on temperature becomes smooth. Thus set wavelength of the pumping light can be pre-stored in the controller 17, or can be inputted through a proper input means when the optical amplifier 1 is used.

Also, the optical amplifier 1 comprises a gain equalizer 18, and optical isolators 19a, 19b. The gain equalizer 18 is provided on the light propagation path P1 positioned downstream from the amplification optical fiber 13 (or a position closer to the light output terminal 12 than the amplification optical fiber 13). The gain equalizer 18 equalizes the gain spectrum of the amplification optical fiber 13 and compensates for the temperature dependence of the gain spectrum of the amplification optical fiber 13. The gain equalizer 18 includes, for example, a long-period fiber grating (LPG) with a loss spectrum that has a similar characteristic to that of the gain spectrum of the amplification optical amplifier 13. Thus, the gain equalizer 18 can flatten the gain spectrum at a constant temperature, and compensates for the temperature dependence of the gain spectrum by using wavelength shift due to temperature fluctuation of the LPG.

On the optical propagation path P1, the optical isolators 19a, 19b are provided between the light input terminal 11 and the optical coupler 15 and between the amplification optical fiber 13 and the gain compensator 18, respectively. The optical isolators 19a, 19b pass light propagating from upstream to downstream, while intercept light propagating from downstream to upstream.

In the optical amplifier having the above-mentioned configuration, light inputted through the light input terminal 11 is introduced to the amplification optical fiber 13 after passing through the optical isolator 19a and the optical coupler 15. On the other hand, the pumping light, outputted from the pumping light source 15 and having the center wavelength set by the controller 17, is supplied to the amplification optical fiber through the optical coupler 15. After entering the amplification optical fiber 13, the light inputted to the amplification optical fiber 13 is amplified by stimulated emission of Erbium pumped by the pumping light. The amplified light outputted form the amplification optical fiber 13 passes through the optical isolator 19b and then reaches the gain equalizer 18. The amplified light reaching the gain equalizer is outputted to the light output terminal 12 after being induced with loss in accordance with a predetermined loss spectrum such that the gain spectrum of the amplification optical fiber 13 is equalized and the temperature dependence of the gain spectrum is compensated, suitably.

Next, the effects of the optical amplifier 1 shown in FIG. 1 will now be explained. The optical amplifier 1 comprises an EDF as an amplification optical fiber 13, and therefore is suitable for use in WDM communication. The amplification optical fiber 13 has an amplification band including wavelengths of 1540 nm or less. The temperature dependence of the gain spectrum in this amplification band varies by a relatively large amount due to the center wavelength of the pumping light. Therefore, the optical amplifier 1, properly sets the center wavelength of the pumping light based on the relationship between the temperature dependence of the gain spectrum and the center wavelength of the pumping light, is particularly useful.

Furthermore, the wavelength of the pumping light supplied from the pumping light supplier 14 into the amplification optical fiber 13 is set such that the gain variation spectrum of the amplification optical fiber 13 depending on temperature. Accordingly, the pumping light having the center wavelength suitable for compensation for the temperature dependence of the gain spectrum of the amplification optical fiber 13 can be supplied to the amplification optical fiber 13. Thus, the optical amplifier 1 capable of sufficiently compensating for the temperature dependence of the gain spectrum can be realized. As a result, the optical amplifier 1 does not require any temperature control of the amplification optical fiber 13, and therefore achieves low electric power consumption and superior economical efficiency.

Here, it is preferable that the wavelength of the pumping light is fixed in the wavelength band of 960 nm or more but 980 nm or less. In this case, the temperature dependence of the gain spectrum of the amplification optical fiber 13 varies depending on the wavelength of the pumping light. Therefore, by properly setting the wavelength of the pumping light within the above wavelength band, the temperature dependence of the gain spectrum of the amplification optical fiber 13 can be made easy to compensate for. From this matter, the optical amplifier 1 is particularly useful. More preferably, the wavelength of the pumping light is fixed in the wavelength band of 974 nm or more but 977 nm or less. In this case, the temperature dependence of the gain spectrum becomes easy to compensate. From this matter, the compensation for temperature dependence of the gain spectrum can be sufficiently achieved.

Since the optical amplifier 1 comprises the gain equalizer 18, the temperature dependence of the gain spectrum in the amplification optical fiber 13 is compensated and the amplified light whose gain spectrum is equalized can be outputted. Additionally, the optical amplifier 1 comprises the optical isolator 19a, and therefore can prevent the light back-reflected by the light output terminal 12 from reaching the light input terminal 11. Similarly, the optical amplifier 1 comprises the optical isolator 19a, and therefore can prevent the light back-reflected by the gain equalizer 18 or the light output terminal 12 from entering the amplification optical fiber 13.

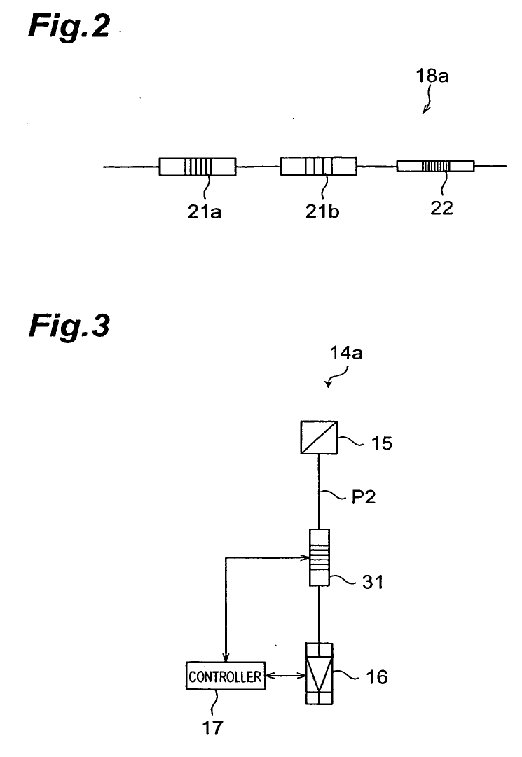

FIG. 2 is a view showing an example of configuration of the gain equalizer 18 in the optical amplifier 1 shown in FIG. 1. The gain equalizer 18a shown in FIG. 2 has a structure that LPGs 21a, 21b and a fiber Bragg grating (FBG) 22 are connected in series.

Each of the LPGs 21a, 21b comprises a core included in the light propagation region and a cladding provided on the outer periphery of the core, and an optical fiber in which a core only is doped with Ge is applied as a host fiber. This optical fiber has a reflective index variation with a constant period and phase along its longitudinal direction. The loss spectra of these LPGs 21a, 21b have temperature dependence, since wavelength shifts in their loss spectra are caused by temperature fluctuation induce. The LPGs 21a, 21b are designed such that their loss spectra have different characteristics and temperature dependence. In the configuration as shown in FIG. 2, the period of reflective index variation, the length and other parameters of each of the LPGs 21a, 21b are properly adjusted such that the temperature dependence of the entire loss spectrum of the LPGs 21a, 21b becomes as similar as possible to that of the gain spectrum of the amplification optical fiber 13.

On the other hand, the FBG 22 has a constant loss spectrum with no temperature dependence. The FBG 22 is designed such that the loss spectrum of the entire gain equalizer 18a including the FBG 22 together with the LPG 21a, 21b becomes as similar as possible to the gain spectrum of the amplification optical fiber 13.

With the configuration of FIG. 2, the LPGs 21a, 21b in the gain equalizer 18a compensate for the temperature dependence of the gain spectrum of the amplification optical fiber 13. Therefore, it is possible to compensate for the temperature dependence of the gain spectrum with a simple configuration. Further, since the LPGs 21a, 21b, which are passive optical elements, are used for temperature compensation, the gain equalizer 18a consumes no electric power, thereby reducing electric power consumption of the optical amplifier 1.

Furthermore, the gain equalizer 18a is configured to compensate for the temperature dependence of the gain spectrum is compensated for by combining the loss spectrum characteristics of the two LPGs 21a, 21b. Thus, it is possible to realize a complex loss spectrum characteristic, and even when the gain spectrum to be compensated has a complex characteristic, the temperature dependence of the gain spectrum can be sufficiently compensated for. One or more LPGs may be used. In the case that three or more LPGs are used, it is possible to realize a more complex loss spectrum characteristic.

The two LPGs 21a,21b have different loss spectrum characteristics and different temperature dependence of loss spectrum. Therefore, more complex loss spectrum characteristics can be realized, as compared to the case two LPGs having the same characteristic are combined. However, the two LPGs 21a, 12b may be designed to have the same characteristic.

To the LPGs 21a, 21b, an optical fiber in which only the core has been doped with Ge is applied as a host fiber. Thus, it is possible to realize a LPG with large wavelength shift of loss spectrum due to temperature fluctuation. When large amount of wavelength shift is obtained, the loss spectrum can be sensitively changed with temperature fluctuation. Thus, even when the gain spectrum varies by large amount with temperature fluctuation, the temperature dependence of the gain spectrum can be sufficiently compensated. Furthermore, it is preferable to design the LPG such that the variation of its loss spectrum due to temperature fluctuation becomes 40 pm/° C. or more.

The FBG 22 included in the gain equalizer 18a cooperates with the two LPGs 21a,21b to equalize the gain spectrum. Therefore, the gain spectrum can be properly equalized by the gain equalizer 18a with a simple configuration. In particular, the FBG 22 can control the loss spectrum more sensitively compared to other filters, and therefore, even when the gain spectrum at a constant temperature has a complex characteristic, the gain spectrum can be sufficiently equalized.

FIG. 3 is a view showing an example of modification of the pumping light supplier 14 shown in FIG. 1. The pumping light supplier 14a is similar to the pumping light supplier 14 of FIG. 1 in that the optical coupler 15 and the pumping light source 16 are connected to the opposite ends of the path P2 and in that the controller 17 is connected to the pumping light source 16, but is different from the pumping light supplier 14 of FIG. 1 in that a FBG 31 is provided on the path P2 between the optical coupler 15 and the pumping light source 16. Also, the controller 17 is connected to the FBG 31.

The FBG 31 is a wavelength stabilizer for stabilizing the center wavelength of pumping light set by the controller 17. Specifically, depending on the center wavelength set by the controller 17, the FBG 31 has a reflection spectrum characteristic with a narrow width centered on the center wavelength. Thus, the FBG 31 narrows the spectrum width of the pumping light outputted from the pumping light source 16 to an extremely narrow width around a desired center wavelength, and also suppresses the wavelength fluctuation of the pumping light to be supplied to the amplification optical fiber 13 for wavelength stabilization.

At this time, the controller 17 changes the reflection spectrum characteristic of the FBG 31 depending on a desired center wavelength, by adjusting the grating spacing with tension, e.g. However, it is not essential that the reflection spectrum characteristic of the FBG 31 is variable, and a FBG 31 having a reflection spectrum with a desired fixed center wavelength may be used as a wavelength stabilizer. In this case, it is not necessary to connect the controller 17 to the FBG 31.

With the configuration of FIG. 3, since the FBG 31 stabilizes the center wavelength of the pumping light outputted from the pumping light source 16, the center wavelength of pumping light supplied to the amplification optical fiber 13 can be kept constant. Thus, it is possible to suppress a gain spectrum variation caused by a variation in the center wavelength of the pumping light. As a result, compensation for the temperature dependence of the gain spectrum and flattening of the gain spectrum can be achieved more effectively.

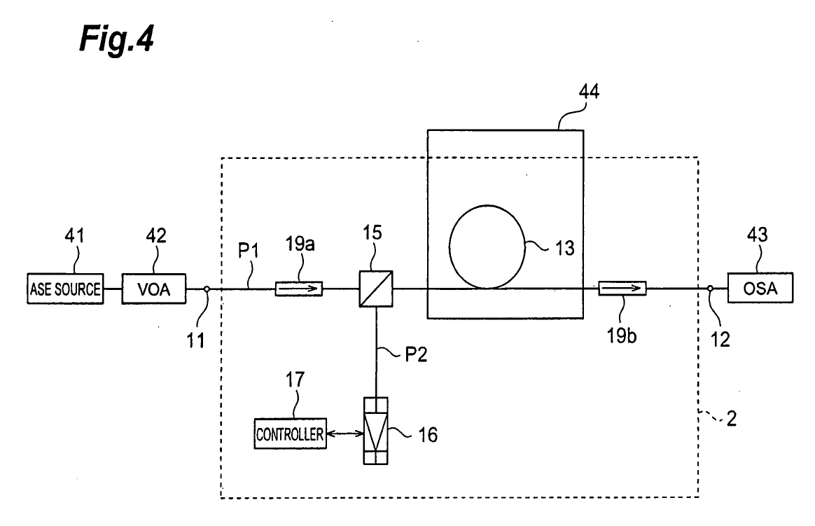

FIG. 4 is a view showing a configuration of an experiment system for determining the relationship between the gain spectrum of the amplification optical fiber 13 and the center wavelength of the pumping light In the experiment system shown in FIG. 4, an Amplified Spontaneous Emission light source (ASE light source) 41 is connected to the light input terminal 11 side of the optical amplifier 2 through a variable light attenuator (VOA) 42, while an optical spectrum analyzer (OSA) 43 is connected to the light output terminal 12 side.

The optical amplifier 2 is similar to the optical amplifier 1 shown in FIG. 1 except that the gain compensator 18 is eliminated. That is, in the optical amplifier 2, an optical isolator 19a, an optical coupler 15, an amplification optical fiber 13 and an optical isolator 19b are provided, in the order of mention, on a light propagation path P1 extending from the light input terminal 11 to the light output terminal 12. Further, a pumping light propagation path P2 is connected to one end to the optical coupler 15, and a pumping light source 16 is connected to the other end of the pumping light propagation path P2. A controller 17 is connected to the pumping light source 16.

The procedure of the experiment is as follows. At first, as light to be amplified, light with a wavelength band of 1525 nm to 1570 nm is inputted to the optical amplifier 2 from the ASE light source 41. Here, the intensity of the light inputted into the optical amplifier 2 is properly adjusted with the VOA 42. Further, the pumping light from the pumping light source 16 is supplied to the amplification optical fiber 13. The controller 17 sets the center wavelength of the pumping light to various values in the wavelength band of 960 nm or more but 990 nm or less, and the OSA 43 measures the temperature dependence of the gain spectrum, for each of the pumping light wavelengths. Here, in order to properly control the temperature of the amplification optical fiber 13, this experiment is performed in the condition that the amplification optical fiber 13 is placed in a constant-temperature bath 44 of temperature-adjustable type.

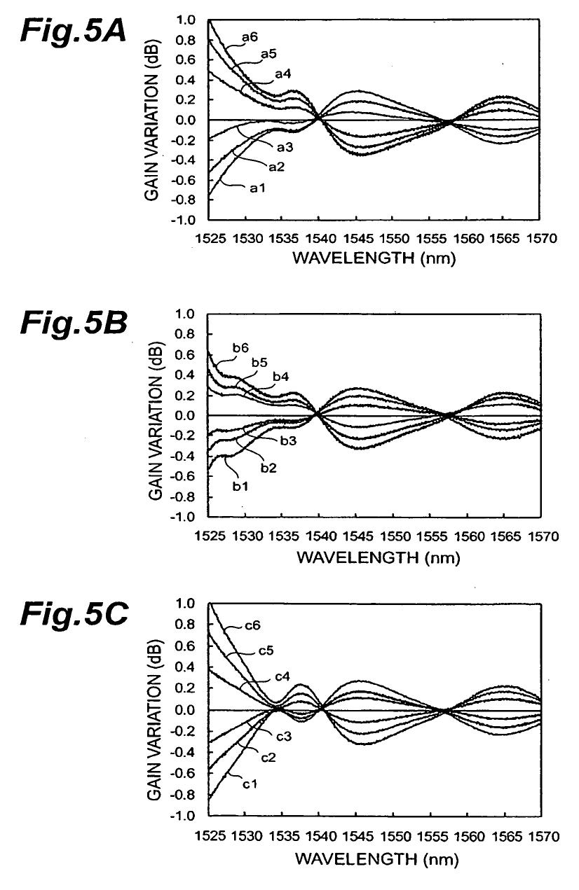

FIG. 5A is a graph showing a measurement result of the temperature dependence of the gain spectra for center wavelengths of 973.3 nm, FIG. 5B is a graph showing a measurement result of the temperature dependence of the gain spectra for center wavelengths of 975.7 nm, and FIG. 5C is a graph showing a measurement result of the temperature dependence of the gain spectra for center wavelengths of 980.2 nm. In each of FIGS. 5A to 5C, the vertical axis represents gain variation (dB), and the horizontal axis represents the wavelength of amplified light (nm). Here, the gain variation value means as a relative value on the basis of the gain obtained when the temperature of the amplification optical fiber 13 is 25° C. Namely, each of the curves a1 to a6 of FIG. 5A, the curves b1 to b6 of FIG. 5B and the curves c1 to c6 of FIG. 5c represents a spectrum corresponding to the difference obtained by subtracting the gain spectrum measured at 25° C. from the gain spectrum at each measurement temperature. In this specification, these curves a1 to a6, b1 to b6 and c1 to c6 mean as “gain variation spectrum” of the amplification optical fiber 13 depending on temperature.

The curves a1, b1 and c1 are gain variation spectra measured in the condition that the temperature (corresponding to the temperature of the constant-temperature bath 44) is set to −10° C., the curves a2, b2 and c2 are gain variation spectra measured in the condition that the temperature (corresponding to the temperature of the constant-temperature bath 44) is set to 0°, the curves a3, b3 and c3 are gain variation spectra measured in the condition that the temperature (corresponding to the temperature of the constant-temperature bath 44) is set to 10° C., the curves a4, b4 and c4 are gain variation spectra measured in the condition that the temperature (corresponding to the temperature of the constant-temperature bath 44) is set to 45° C., the curves a5, b5 and c5 are gain variation spectra measured in the condition that the temperature (corresponding to the temperature of the constant-temperature bath 44) is set to 65° C., and the curves a6, b6 and c6 are gain variation spectra measured in the condition that the temperature (corresponding to the temperature of the constant-temperature bath 44) is set to 85° C.

From the results shown in FIGS. 5A to C, it can be confirmed that the temperature dependence of the gain variation spectra varied depending on the center wavelength of the 980 nm-band pumping laser. In particular, in the shorter wavelength side than 1540 nm, it is also revealed that the dependence of the gain variation spectra on the pumping light wavelength varied significantly. Further, in this experiment, the average gain of the amplification optical fiber 13 is 23.5 dB.

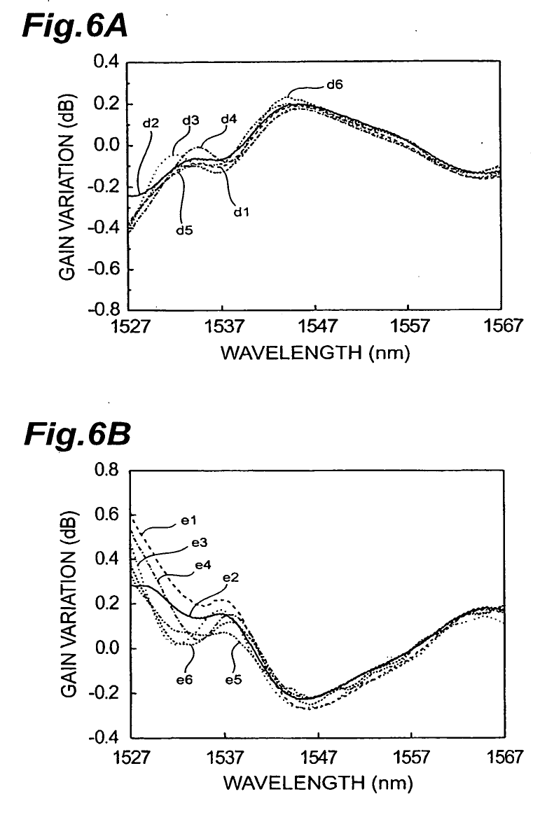

FIG. 6A is a graphs showing the gain variation spectra when changing the temperature (corresponding to the temperature of the constant-temperature bath 44) of the amplification optical fiber 13 from 25° C. to 0° C. FIG. 6B is a graph showing the gain variation spectra when changing the temperature (corresponding to the temperature of the constant-temperature bath 44) of the amplification optical fiber 13 from 25° C. to 65° C. In each of FIGS. 6A and 6B, the gain variation values represented with the vertical axis represents the amount of gain variation from the gain obtained at 25° C. The curves d1 and e1 represent the gain variation spectra measured while setting the center wavelength of the pumping light to 973.3 nm, the curves d2 and e2 represent the gain variation spectra measured while setting the center wavelength of the pumping light to 975.7 nm, the curves d3 and e3 represent the gain variation spectra measured while setting the center wavelength of the pumping light to 978.4 nm, the curves d4 and e4 represent the gain variation spectra measured while setting the center wavelength of the pumping light to 980.2 nm, the curves d5 and e5 represent the gain variation spectra measured while setting the center wavelength of the pumping light to 982.0 nm, and the curves d6 and e6 represent the gain variation spectra measured while setting the center wavelength of the pumping light to 984.0 nm.

From the results shown in FIGS. 6A and 6B, it is revealed that, for the center wavelengths of 973-3 nm and 975.7 nm, the gain variations increase or decrease in relatively monotonous manners in the wavelength band of 1540 nm or less, while for the other center wavelengths the gain variation spectra have complex characteristics.

As described above, LPGs can be advantageously used as a configuration for compensating for the temperature dependence of the gain spectrum. In general, the loss variation spectrum (a spectrum corresponding to the difference obtained by subtracting the loss spectrum at a reference temperature from the loss spectrum at a predetermined temperature) of LPG increases or decreases with respect to the wavelength in a monotonous manner. See, for example, FIG. 2 of Document 2 and FIG. 2 of Document 3. Therefore, the temperature compensation for the gain variation spectrum can be easier for the center wavelengths setting of 973.3 nm and 975.7 nm where the gain varies with wavelength in a relatively monotonous manner, than for the other center wavelength setting.

As drawing a comparison between the cases of the center wavelength settings of 973.3 nm and 975.7 nm, the gain variations due to temperature fluctuation are smaller for the latter case than for the former case, as shown in FIGS. 5A to 5C and FIGS. 6A and 6B. The more gain variations due to temperature fluctuation are larger, the more the LPG having a loss spectrum that largely varies sue to temperature fluctuation should be used. Therefore, it is preferable that the center wavelength of the pumping light is set to 975.5 nm such that the gain variation due to temperature fluctuation becomes smaller in the region of shorter wavelength side than 1540 nm. In this case, even when the LPG with a low peak loss is applied, the temperature dependence of the gain spectrum can be sufficiently compensated. Therefore, a gain spectrum easy to temperature-compensate can be realized. Further, the more the peak loss is low, the manufacturability of LPG can be enhanced. Because, the UV radiation time during manufacturing can be shortened.

As described above, the present inventors have arrived at the conclusion that it is preferable to set the center wavelength of the pumping light based on the relationship between the temperature dependence of the gain spectrum and the center wavelength of the pumping light. Furthermore, they have found that it is more preferable to stabilize the center wavelength of the pumping light in the wavelength band of 974 nm to 977 nm.

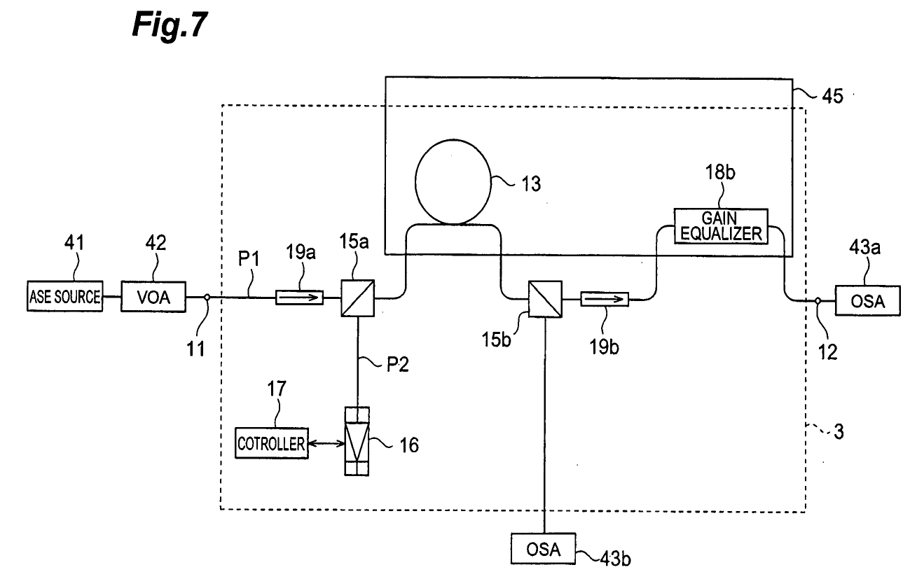

Thus, the present inventors have actually performed the experiment compensating for the temperature dependence of the gain spectrum in the case that the center wavelength of the pumping light is set to 975.5 nm. FIG. 7 is a view showing a configuration of the experiment system prepared for this experiment. In the experiment system shown in FIG. 7, the ASE light source 41 is connected to the input light terminal 11 side of the optical amplifier 3 through the VOA 42 and the OSA 43a is connected to the light output terminal 12 side.

The optical amplifier 3 is similar to the optical amplifier 1 shown in FIG. 1 except two optical couplers 15a, 15b are provided. That is, in the optical amplifier 3, an optical isolator 19a, an optical coupler 15a, an amplification optical fiber 13, an optical coupler 15b an optical isolator 19b, and a gain compensator 18 are provided, in the order of mention, on the light propagation path P1 extending from the light input terminal 11 to the light output terminal 12. Further, the pumping light propagation path P2 is connected to one end to the optical coupler 15a, and the pumping light source 16 is connected to the other end of the pumping light propagation path P2. The controller 17 is connected to the pumping light source 16. Here, the optical coupler 15b is connected to an OSA 43b provided apart from the optical amplifier 3. The optical coupler 15a outputs a part of the light outputted from the amplification optical fiber 13 to the OSA 43b, and the OSA 43b measures the gain spectrum of the amplification optical fiber 13.

Also, the gain equalizer 18b has a structure such that two LPGs and one FBG are connected in series, as similar to the gain equalizer 18a shown in FIG. 2. The LPG is formed from a host fiber only the core of which had been doped with Ge and configured to have a reflective index variation with a constant period and phase along its longitudinal direction. On the other hand, the FBG is configured to have a loss spectrum that was not varied with temperature fluctuation. In order to properly make the gain equalizer 18b, the gain spectrum and the gain variation spectrum of the amplification optical fiber 13 in the case of setting the center wavelength of the pumping light to 975.7 nm are referred.

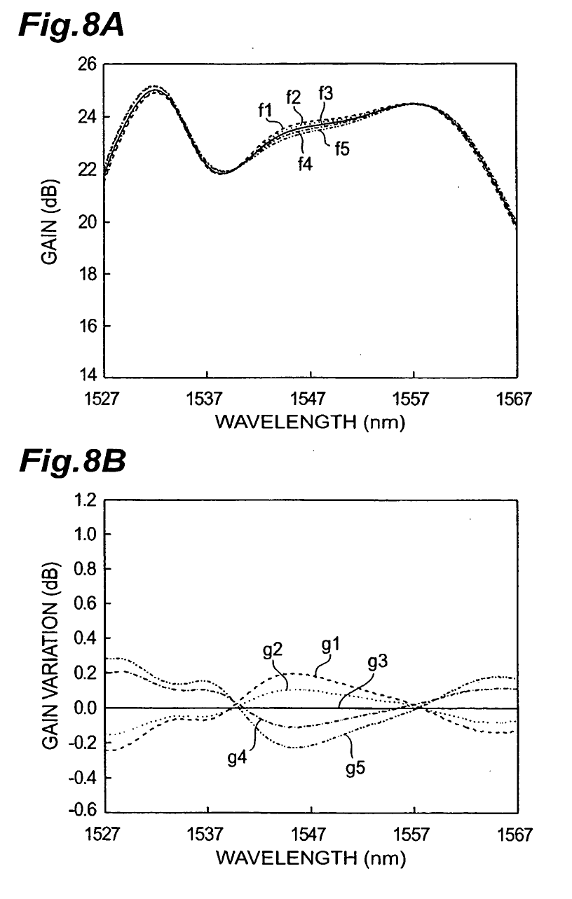

FIG. 8A is a graph showing the temperature dependence of the referred gain spectrum (gain spectrum of the amplification optical fiber when setting the center wavelength of the pumping light to 975.7 nm). FIG. 8B is a graph showing the temperature dependence of the referred gain variation spectrum (gain variation spectrum of the amplification optical fiber when setting the center wavelength of the pumping light to 975.7 nm). These spectra are spectra measured by the experiment system shown in FIG. 4. In FIG. 8A, the vertical axis represents the gain (dB), and the horizontal axis represents the wavelength (nm) of light to be amplified. In FIG. 8B, the vertical axis represents the gain variation (dB), and the horizontal axis represents the wavelength (nm) of light to be amplified.

The curve f1 represents the gain spectrum measured when setting the temperature (temperature of the constant-temperature bath 44) to 0° C., the curve f2 represents the gain spectrum measured when setting the temperature (temperature of the constant-temperature bath 44) to 10° C., the curve f3 represents the gain spectrum measured when setting the temperature (temperature of the constant-temperature bath 44) to 25° C., the curve f4 represents the gain spectrum measured when setting the temperature (temperature of the constant-temperature bath 44) to 45° C., and the curve f5 represents the gain spectrum measured when setting the temperature (temperature of the constant-temperature bath 44) to 65° C.

On the other hand, the curve g1 represents the gain variation spectrum measured when setting the temperature (temperature of the constant-temperature bath 44) to 0° C., the curve g2 represents the gain variation spectrum measured when setting the temperature (temperature of the constant-temperature bath 44) to 1.0° C., the curve g3 represents the gain variation spectrum measured when setting the temperature (temperature of the constant-temperature bath 44) to 25° C., the curve g4 represents the gain variation spectrum measured when setting the temperature (temperature of the constant-temperature bath 44) to 45° C., and the curve g5 represents the gain variation spectrum measured when setting the temperature (temperature of the constant-temperature bath 44) to 65° C.

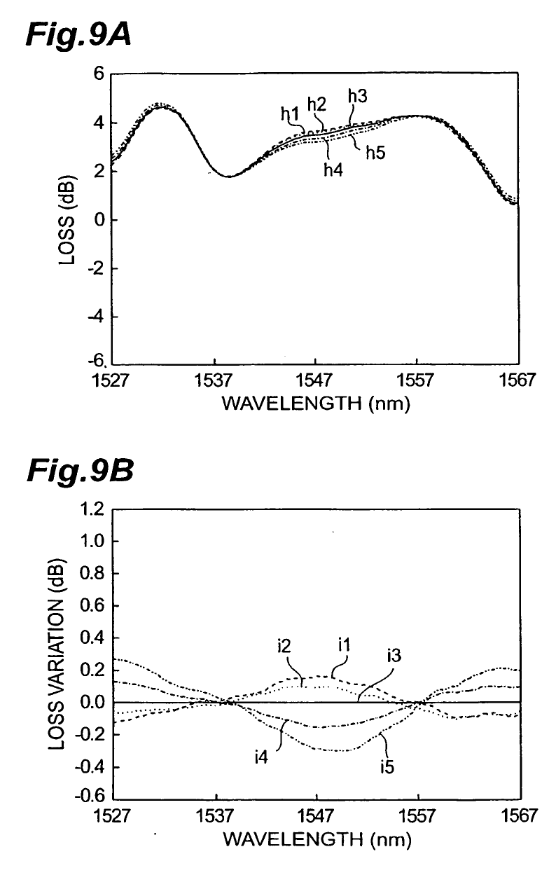

Furthermore, FIG. 9A is a graph showing the loss spectrum of the gain equalizer 18b made with reference to FIG. 8A, and FIG. 9B is a graph showing the temperature dependence of the loss variation spectrum of gain equalizer 18b made with reference to FIG. 8B. In FIG. 9A, the vertical axis represents the loss (dB), and horizontal axis represents the wavelength (nm) of light to be amplified. Also, in FIG. 9B, the vertical axis represents the loss variation (dB), and the horizontal axis represents the wavelength (nm) of light to be amplified.

Here, the curves h1 to h5 in FIG. 9A show the loss spectra measured at the same measurement condition as that of FIG. 8A, and the curves h1 to h6 in FIG. 9B show the loss variation spectra (the reference temperature: 25° C.) measured at the same measurement condition as that of FIG. 8B. The wavelength shift induced by the temperature is about 50 pm/° C., which is relatively large value.

Light to be amplified is inputted from the ASE source 41 into the optical amplifier 3 having the above-mentioned gain equalizer 18b, and the output of the optical amplifier 3 is measured with the OCA43a (see FIG. 7). Here, in order to properly control the temperature of the amplification optical fiber 13 and the gain control 18b, the measurement is performed in the condition that the amplification optical fiber 13 and the gain compensator 18b placed in the constant-temperature bath 45 of temperature-adjustable type.

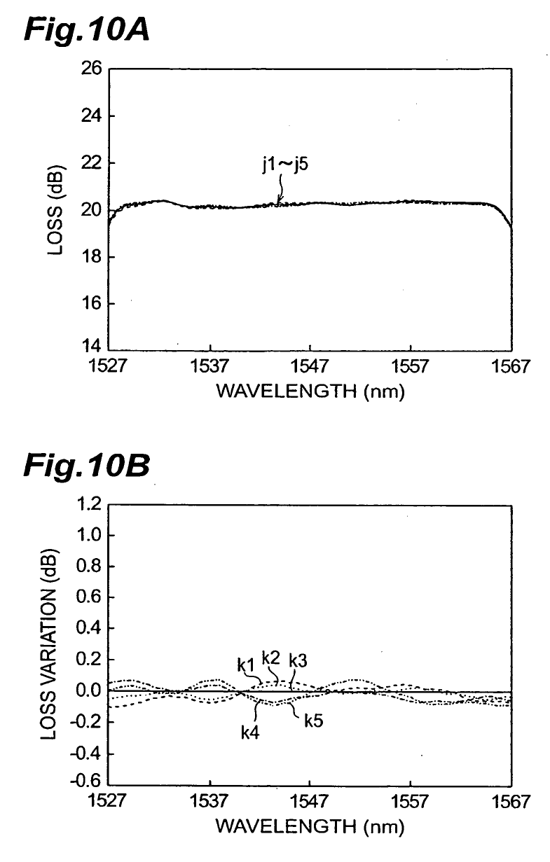

FIG. 10A is a graph showing the gain spectrum of the entire optical amplifier 3, and FIG. 10B is a graph showing the temperature dependence of the gain variation spectrum of the entire optical amplifier 3. The vertical and horizontal axes in FIG. 10A represent the same parameters as those in FIG. 8A, and the vertical and horizontal axes in FIG. 10B represent the same parameters as those in FIG. 8B.

In addition, the curves j1 to j5 represent loss spectra measured at the same measurement condition as that of FIG. 8A, and the curves k1 to k5 represent loss variation spectra measured at the same measurement condition as that of FIG. 8B. These results revealed that gain due to the temperature fluctuation was drastically reduced and the temperature dependence of the gain spectrum was properly compensated.

In accordance with the present invention, it is possible to realize an optical amplifier capable of compensating for the temperature dependence of the gain spectrum. Further, the optical amplifier according to the present invention does not require temperature control of the amplification medium and therefore reduces electric power consumption, thereby realizing superior economical efficiency as a result. The optical amplifier according to the present invention can be applied a WDM communication system which transmits signal light of multiplexed plural channels with wavelengths different from each other and which is suitable to both large capacity transmission and long-haul transmission.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical amplifier comprising:
an amplification medium having a light propagation region which is doped with a rare earth element and in which light propagating therethrough is amplified by the supply of pumping light with a predetermined wavelength;
a pumping light supplier for supplying pumping light, whose wavelength is set such that a gain variation spectrum of said amplification medium depending on temperature becomes smooth, into said amplification medium; and
an equalizer for equalizing a gain spectrum of said amplification medium and for compensating for temperature dependence of the gain spectrum of said amplification medium.

2. An optical amplifier according to claim 1, wherein said pumping light supplier supplies the pumping light, whose wavelength is fixed in the wavelength band of 960 nm or more but 990 nm or less, into said amplification medium.

3. An optical amplifier according to claim 2, wherein said pumping light supplier supplies the pumping light, whose wavelength is fixed in the wavelength band of 974 nm or more but 977 nm or less, into said amplification medium.

4. An optical amplifier according to claim 1, wherein an amplification band of said amplification medium includes wavelengths of 1540 nm or less.

5. An optical amplifier according to claim 1, wherein said equalizer includes a long-period fiber grating having a loss spectrum with temperature dependence.

6. An optical amplifier according to claim 5, wherein said long-period fiber grating has a constant period and a constant phase of reflective index fluctuation along its longitudinal direction.

7. An optical amplifier according to claim 5, wherein said long-period fiber grating is fabricated by using an optical fiber comprising a core which extends along a predetermined axis and is doped with Ge, and a cladding which is provided on an outer periphery of said core and is not doped with Ge.

8. An optical amplifier according to claim 5, wherein said long-period fiber grating has a loss spectrum whose variation with respect to temperature fluctuation is 40 pm/° C. or more.

9. An optical amplifier according to claim 5, wherein said equalizer includes a filter having a constant loss spectrum with no temperature dependence.

10. An optical amplifier according to claim 9, wherein said filter includes a fiber Bragg grating or a dielectric interference filter.

11. An optical amplifier according to claim 1, wherein said equalizer includes a plurality of long-period fiber gratings each having a loss spectrum with temperature dependence.

12. An optical amplifier according to claim 11, wherein each of said long-period fiber gratings has a constant period and a constant phase of a reflective index fluctuation along its longitudinal direction.

13. An optical amplifier according to claim 11, wherein each of said long-period fiber gratings is fabricated by using an optical fiber comprising a core which extends along a predetermined axis and is doped with Ge, and a cladding which is provided on an outer periphery of said core and is not doped with Ge.

14. An optical amplifier according to claim 11, wherein each of said long-period fiber gratings has a loss spectrum whose variation with respect to temperature fluctuation is 40 pm/° C. or more.

15. An optical amplifier according to claim 11, wherein said equalizer includes a filter having a constant loss spectrum with no temperature dependence.

16. An optical amplifier according to claim 15, wherein said filter includes a fiber Bragg grating or a dielectric interference filter.

17. An optical amplifier according to claim 1, wherein said pumping light supplier includes a stabilizer for stabilizing a center wavelength of the pumping light to be supplied therefrom.
